(19) United States
(12) Patent Application Publication
(10) Pub. No.: US 2026/0367971 A1
(43) Pub. Date: Nov. 19, 2026

(54) METHOD AND APPARATUS FOR IDENTIFYING THREAD ASSOCIATED WITH UI RESPONSIVENESS OF APPLICATION

(71) Applicant: SAMSUNG ELECTRONICS CO., LTD., Suwon-si (KR)

(72) Inventors: Iksoon KIM, Suwon-si (KR); Kyungmin KANG, Suwon-si (KR); Jihoon KIM, Suwon-si (KR); Changhyeon CHAE, Suwon-si (KR); Youngjin KIM, Suwon-si (KR); Kyeonghwan JUNG, Suwon-si (KR); Gwanggyun JEONG, Suwon-si (KR); Youngho CHOI, Suwon-si (KR)

(73) Assignee: SAMSUNG ELECTRONICS CO., LTD., Suwon-si (KR)

(21) Appl. No.: 19/728,645

(22) Filed: Jul. 2, 2026

Related U.S. Application Data
(63) Continuation of application No. PCT/KR2025/000151, filed on Jan. 3, 2025.

(30) Foreign Application Priority Data
Jan. 4, 2024 (KR) 10-2024-0001356

(51) Int. Cl. G06F 9/48; G06F 9/451

(52) U.S. Cl. CPC G06F 9/4881; G06F 9/451

(57) ABSTRACT

An electronic apparatus configured to: acquire TID information of a first thread configured to process a task related to rendering of a UI; based on the TID information, identify whether the first thread belongs to a process of an application associated with a top window; based on identifying that the first thread belongs to the process of the application associated with the top window, include in a thread list the first thread and a second thread that belongs to a same process as the first thread and is configured to process a task related to the UI, the thread list being configured to process a task related to the UI. Threads in the thread list are associated with the UI operation are configured to have applied thereto scheduling configurations different from at least one thread that belongs to the process and is not included in the thread list.

### CROSS-REFERENCE TO RELATED APPLICATIONS

This application is a continuation application of International Application No. PCT/KR2025/000151, filed on Jan. 3, 2025, which claims priority from Korean Patent Application No. 10-2024-0001356, filed Jan. 4, 2024, the disclosures of which are hereby incorporated by reference herein in their entireties.

### TECHNICAL FIELD

The disclosure relates to a method and apparatus for identifying a thread associated with UI responsiveness of an application.

### BACKGROUND ART

As technology develops and advances, an electronic device may provide various functions in addition to its inherent functions. For example, a television (TV) may not only display broadcast channels, but may also provide functions of executing an application, accessing a website, or performing communication with another electronic device.

An electronic device such as a TV may provide a multi-process environment in which a plurality of processes can be executed. In an electronic device providing a multi-process environment, scheduling for efficiently allocating and managing resources may be performed. In general, scheduling may be performed on an application basis. For example, the same scheduling policy is applied to all threads included in a process of one application, and the priorities of the threads may be collectively adjusted.

However, within a process of an application, threads associated with UI responsiveness exist together with threads not associated with UI responsiveness. Therefore, when the same scheduling policy is applied to all of them, or when the priorities of all of them are collectively adjusted, in the event of central processing unit (CPU) contention, a case may occur in which threads associated with UI responsiveness are not sufficiently allocated CPU resources. This causes a degradation of UI responsiveness.

Accordingly, in order to improve UI responsiveness, a scheme is needed for identifying threads associated with UI responsiveness within a process of an application and for applying a separate scheduling setting to the identified threads.

### DISCLOSURE OF INVENTION

### Solution to Problems

An electronic device according to an embodiment of the disclosure includes a memory to store at least one program; and at least one processor electrically connectable with the memory and configured to execute at least one instruction of the at least one program stored in the memory. The at least one processor includes processing circuitry and, individually and/or collectively, is configured to: obtain thread ID (TID) information of a first thread configured to process a task related to rendering of a user interface (UI) to be displayed, identify, based on the TID information, whether the first thread belongs to a process of an application associated with a top window among at least one window displayed on a screen, and include in a thread list the first thread and a second thread that belongs to a same process as the first thread and that is configured to process a task related to the UI based on the first thread being identified as belonging to the process of the application associated with the top window, the thread list being associated with a UI operation of the application, wherein threads included in the thread list including the first thread and the second thread that are associated with the UI operation may be configured such that a scheduling setting different from at least one thread that belongs to the process and is not included in the thread list associated with the UI operation is enabled to be applied.

A method of an electronic device includes obtaining thread ID (TID) information of a first thread configured to process a task related to rendering of a user interface (UI) to be displayed; identifying, based on the TID information, whether the first thread belongs to a process of an application associated with a top window among at least one window displayed on a screen; and including in a thread list the first thread and a second thread that belongs to a same process as the first thread and that is configured to process a task related to the UI based on the first thread being identified as belonging to the process of the application associated with the top window, the thread list being associated with a UI operation of the application. The threads included in the thread list including the first thread and the second thread that are associated with the UI operation may be configured such that a scheduling setting different from at least one thread that belongs to the process and is not included in the thread list associated with the UI operation is enabled to be applied.

### BRIEF DESCRIPTION OF DRAWINGS

FIG. 1 is a graph for explaining task processing delay caused by CPU contention according to an embodiment of the disclosure.

FIG. 2 is a graph illustrating context switch latency that may occur depending on a scheduling scheme according to an embodiment of the disclosure.

FIG. 3 is a view illustrating an example of an electronic device according to an embodiment of the disclosure.

FIG. 4A is a signal flow diagram illustrating an operation in which an electronic device processes a user input for an application according to an embodiment of the disclosure.

FIGS. 4B and 4C are views illustrating an arrangement relationship between a screen including a multi-view and windows corresponding to the multi-view according to an embodiment of the disclosure.

FIG. 5 is a system architecture diagram for CPU scheduling of an electronic device according to an embodiment of the disclosure.

FIG. 6 illustrates an example in which a scheduling scheme is applied to an application according to an embodiment of the disclosure.

FIG. 7 is a flowchart illustrating an operation of selecting a thread related to a UI operation according to an embodiment of the disclosure.

FIG. 8 is a flowchart illustrating an operation of an application for selecting a thread related to a UI operation according to an embodiment of the disclosure.

FIG. 9 is a flowchart illustrating an operation of a window manager for selecting a thread related to a UI operation according to an embodiment of the disclosure.

FIG. 10 is a flowchart illustrating an operation of a booster module for selecting a thread related to a UI operation according to an embodiment of the disclosure.

FIG. 11 is a signal flow diagram illustrating a procedure of selecting a thread related to a UI operation according to an embodiment of the disclosure.

FIG. 12 is a flowchart illustrating an operation of registering a thread associated with a UI operation according to an embodiment of the disclosure.

FIG. 13 is a flowchart illustrating an operation of requesting registration for a thread associated with a UI operation according to an embodiment of the disclosure.

FIG. 14 is a flowchart illustrating an operation of managing a thread list associated with a UI operation according to an embodiment of the disclosure.

FIG. 15 is a view illustrating a UI responsiveness improvement effect according to an embodiment of the disclosure.

FIG. 16 is a block diagram illustrating an electronic device according to an embodiment of the disclosure.

### MODE FOR THE INVENTION

Hereinafter, embodiments of the disclosure will be described in detail with reference to the drawings so that those of ordinary skill in the art to which the disclosure pertains can easily carry out the disclosure. However, the disclosure may be implemented in various different forms and is not limited to the embodiments described herein. In connection with the description of the drawings, the same or similar reference numerals may be used for the same or similar components. In addition, in the drawings and the related description, descriptions of well-known functions and configurations may be omitted for clarity and conciseness.

In an electronic device, when a system is busy, such as during cold booting, a phenomenon may occur in which a user interface (UI) response is delayed. One of various causes of the corresponding phenomenon is central processing unit (CPU) contention. CPU contention may represent CPU resource competition in which a plurality of processes (or threads) compete to occupy CPU resources. Due to CPU contention, a case may occur in which a plurality of processes are not allocated as much CPU resources as needed. Due to CPU contention, a process or thread that is not allocated as much CPU resources as needed may have to wait until CPU resources are allocated. In this case, the processing of a task associated with the process or thread may be delayed.

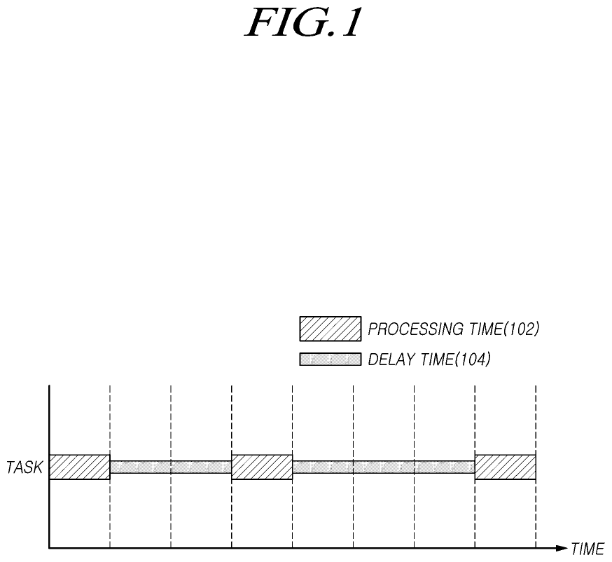

FIG. 1 is a graph for explaining task processing delay caused by CPU contention according to an embodiment of the disclosure.

Referring to FIG. 1, a process (or thread) that is not allocated resources in CPU contention may have task processing delayed until resources are allocated. For example, if a task associated with a process (or thread) has a processing time (or task time) 102 of 0.1 second and waits a time of 1 second until resources are allocated in CPU contention, the processing of the task may be completed after a time of 1.1 seconds has elapsed. That is, the time at which the task is processed may be delayed by a delay time 104 of 1 second. The processing delay of the task may cause inconvenience to a user. For example, if the task is related to processing of key input of a TV remote controller, the user may feel inconvenience because a response to the key input of the TV remote controller is delayed.

In order to allow CPU resource allocation to be performed a little more efficiently, various CPU resource management schemes may be used. For example, in the Linux kernel, a real-time scheduling scheme (hereinafter, referred to as a ‘real-time (RT) scheduling scheme’) and a completely fair scheduler (CFS) scheduling scheme may be used.

The RT scheduling scheme is a scheduling scheme for preempting CPU resources based on priority, and may be used, for example, by a real-time scheduler or an O(1) scheduler. The RT scheduling scheme may be used for a real-time task having the highest priority. In the RT scheduling scheme, a first in first out (FIFO) (or first come first served) policy that allocates CPU resources first to a process (or thread) prepared first, or a round robin policy that allows processes (or threads) to use CPU resources in order, may be used.

The CFS scheduling scheme is a scheduling scheme for fairly allocating CPU resources, and may be used, for example, by a CFS scheduler. The CFS scheduling scheme may be used for a task having a lower priority than a real-time task. The CFS scheduling scheme may be used to allocate CPU resources to processes (or threads) included in each control group based on a CPU resource usage determined per control group (or Cgroup). In the CFS scheduling scheme, a round robin policy may be used.

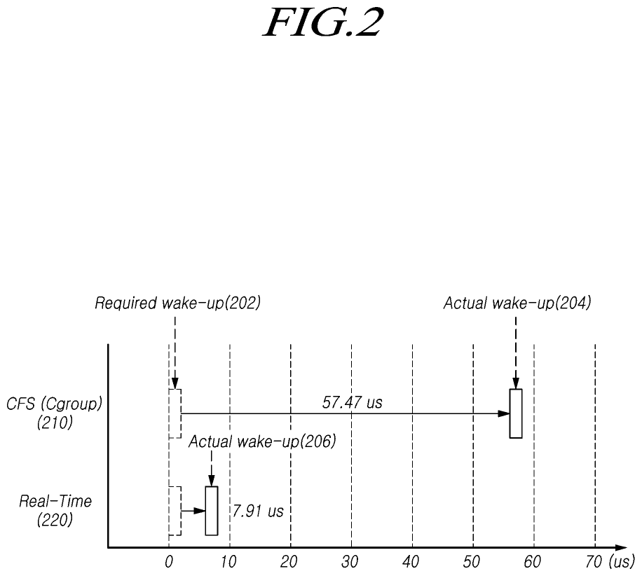

FIG. 2 is a graph illustrating context switch latency that may occur according to a scheduling scheme according to an embodiment of the disclosure.

Referring to FIG. 2, the context switch latency that may occur when the CFS scheduling scheme 210 is used may be longer than the context switch latency that may occur when the real-time (RT) scheduling scheme 220 is used.

The context switch latency may refer to a time delay that occurs in a process switching procedure. For example, the context switch latency may represent a time taken until a process in a waiting state is woken up (wake-up).

According to an example, when the CFS scheduling scheme 210 is used, actual process wake-up 204 may be performed after 57.47 us has elapsed from a requested wake-up time 202. Accordingly, when the CFS scheduling scheme 210 is used, a context switch latency of 57.47 us may occur.

According to an example, when the RT scheduling scheme 220 is used, actual process wake-up 206 may be performed after 7.91 us has elapsed from a requested wake-up time 202. Accordingly, when the RT scheduling scheme 220 is used, a context switch latency of 7.91 us may occur.

The CFS scheduling scheme 210 may prevent CPU starvation from occurring by allowing processes (or threads) to use CPU resources fairly. CPU starvation may represent a state in which another process (or thread) occupies CPU resources, such that a specific process (or thread) cannot use CPU resources. The CFS scheduling scheme 210 has a relatively long context switch latency and does not always guarantee use of CPU resources, and therefore may be used for a task that needs to be performed for a long time.

The RT scheduling scheme 220 may cause a relatively short context switch delay and may guarantee the use of CPU resources until a process transitions itself into a sleep state. Accordingly, the RT scheduling scheme 220 may be easily used for real-time tasks. Since the RT scheduling scheme 220 may cause a CPU starvation state in which other processes (or threads) are unable to use the CPU, it may be used for tasks that need to be performed for a short period of time.

The CFS scheduling scheme 210 and the RT scheduling scheme 220 may be used together in one operating system (OS). For example, by allocating resources to a process (or thread) associated with media (e.g., video or audio) playback based on the RT scheduling scheme 220, CPU usage may be guaranteed and interruption of media playback may be prevented. Resources may be allocated based on the CFS scheduling scheme 210 to a process (or thread) associated with an application executed in the foreground. For example, by allocating the corresponding process (or thread) to a control group capable of using slightly more CPU resources than other processes (or threads), the application may be allowed to be executed smoothly.

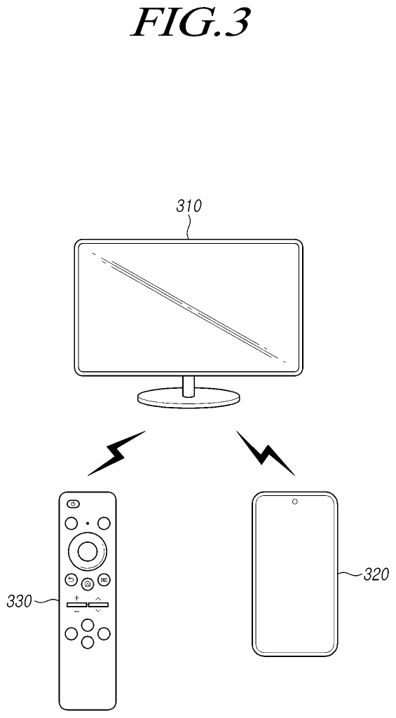

FIG. 3 is a view illustrating an example of an electronic device according to an embodiment of the disclosure.

Referring to FIG. 3, the electronic device 310 may be a display device such as a TV, but is not limited thereto. For example, the electronic device 310 may be a tablet PC, a mobile phone, or various types of devices capable of providing services based on various applications.

According to an embodiment, the electronic device 310 may perform wired and/or wireless communication with at least one external electronic device 320. According to an example, the electronic device 310 may perform wired communication with the at least one external electronic device 320 using a cable (e.g., a high-definition multimedia interface (HDMI) cable). According to an example, the electronic device 310 may perform wireless communication with the at least one external electronic device 320 based on various wireless communication technologies (e.g., wireless fidelity (Wi-Fi), bluetooth, long term evolution (LTE), LTE advance (LTE-A), or new radio (NR) communication technologies).

According to an embodiment, the at least one external electronic device 320 may be, for example, a mobile terminal such as a tablet PC or a mobile phone. The at least one external electronic device 320 is not limited to one as illustrated in FIG. 3, and may be two or more.

According to an embodiment, the electronic device 310 may perform infrared (IR) communication or radio frequency (RF) communication with a remote controller 330. The remote controller 330 may also be referred to as a remote controller or a remote-con, and may include various input units (e.g., a key button, a switch, a wheel, or a touch screen) for controlling the electronic device 310. The remote controller 330 may transmit a control signal for controlling the electronic device 310 to the electronic device 310 based on a user's input through the various input units. According to an example, the control signal may include at least one of a control signal for turning on or off the power of the electronic device 310, a control signal for changing a broadcast channel, a control signal for adjusting volume, a control signal for executing or terminating an application, or a control signal for changing settings related to the electronic device 310.

According to an embodiment, the electronic device 310 may include one or more applications. For example, the electronic device 310 may include at least one application (e.g., an over the top (OTT) application) that provides multimedia content. The electronic device 310 may display the multimedia content provided by the application on a screen. For example, the electronic device 310 may display the multimedia content provided by each application on one screen.

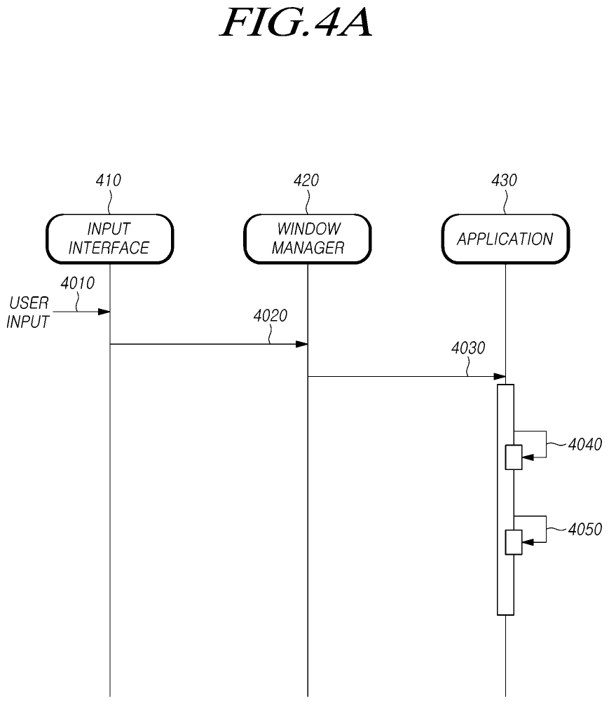

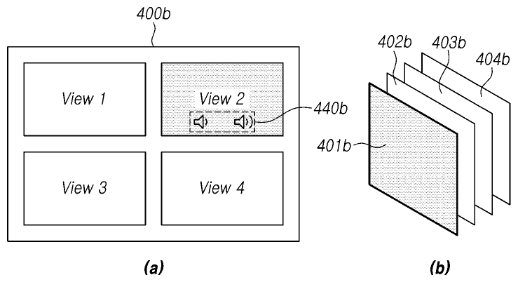

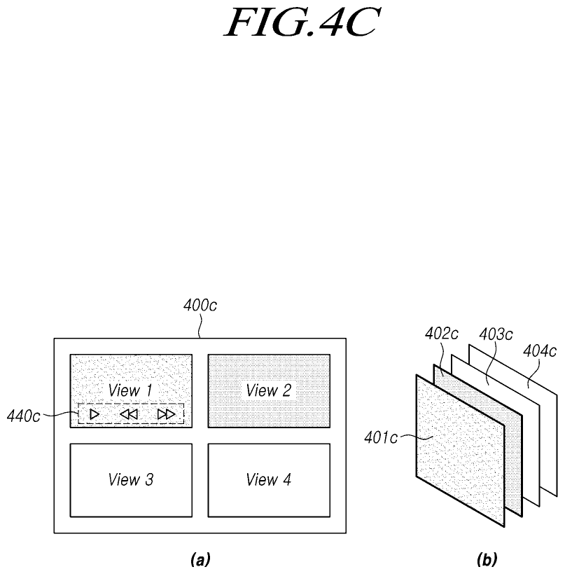

FIG. 4A is a signal flow diagram illustrating an operation in which an electronic device processes a user input for an application according to an embodiment of the disclosure. FIGS. 4B and 4C are views illustrating a screen including a multi-view and an arrangement relationship of windows corresponding to the multi-view according to an embodiment of the disclosure.

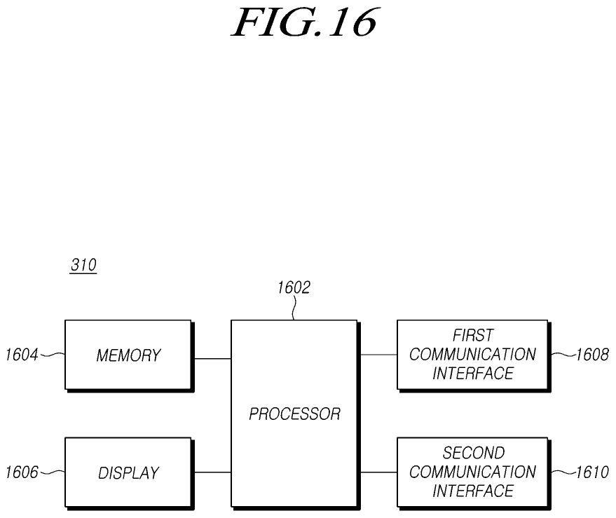

In operation 4010, the electronic device 310 may receive a user input for an application 430 from an external device (e.g., the external electronic device 320 of FIG. 3 or the remote controller 330) through an input interface 410 (e.g., the first communication interface 1608 of FIG. 16 or the second communication interface 1608 of FIG. 16). For example, the user input may be a touch input corresponding to the application 430 received from the external electronic device 320. For example, the user input may be a key input corresponding to the application received from the remote controller 330.

According to an embodiment, the user input for the application 430 may be, for example, a user input corresponding to an event of executing (or re-executing) or selecting the application. For example, the user input for the application 430 may be a user input corresponding to an event of executing or selecting the application 430 through a view corresponding to the application displayed on the screen. The electronic device 310 may provide a UI corresponding to the user input.

According to an embodiment, a view corresponding to the application 430 may be displayed on the screen. For example, a multi-view corresponding to a plurality of applications may be displayed on one screen. For example, as illustrated in portion (a) of FIG. 4B and portion (a) of FIG. 4C, a first view (View 1) corresponding to a first application, a second view (View 2) corresponding to a second application, a third view (View 3) corresponding to a third application, and/or a fourth view (View 4) corresponding to a fourth application may be displayed on one screen. Each view may include the content of the corresponding application.

According to an embodiment, the view corresponding to the application 430 may be displayed on the screen through an associated window. For example, the first view corresponding to the first application may be displayed on the screen through a first window, the second view corresponding to the second application may be displayed on the screen through a second window, the third view corresponding to the third application may be displayed on the screen through a third window, and the fourth view corresponding to the fourth application may be displayed on the screen through a fourth window.

According to an embodiment, each window may have a different layer. For example, as illustrated in portion (b) of FIG. 4B, the second window 401b including the second view may be disposed in the uppermost layer as a top window, the first window 402b including the first view may be disposed in a lower layer immediately next to the uppermost layer, the third window 403b including the third view may be disposed in the next lower layer, and the fourth window 403c including the fourth view may be disposed in the lowermost layer as a top window. The top window or the uppermost layer may correspond to a window or a layer disposed closest to the screen, and the lowermost window or the lowermost layer may correspond to a window or a layer disposed farthest from the screen. In the disclosure, a window set as a top window may also be referred to as a focused window.

According to an embodiment, in each window, an area in which the corresponding view is displayed does not overlap with each other, and an area excluding the area in which the corresponding view is displayed may be processed to be transparent. Through this, even if each window is disposed in a different layer, the view displayed in each window may be shown to a user through one screen.

According to an embodiment, a layer arrangement setting of a window may be changed according to a user input. When a user input corresponding to an event of executing or selecting the application 430 is received, the electronic device 310 (or the window manager 420 of the electronic device 310) may set a window corresponding to the selected or executed application 430 as a top window. For example, as illustrated in portion (b) of FIG. 4B, when the second application corresponding to the second view is selected or executed by a user input, the second window 401b corresponding to the second application may be disposed as a top window. For example, as illustrated in portion (c) of FIG. 4C, when the first application corresponding to the first view is selected by a user input in a state in which the second application corresponding to the second view is selected, the top window may be changed from the second window 402c to the first window 401c. In this case, the second window 402c, which was previously the top window, may be disposed in a lower layer (e.g., a lower layer immediately next) of the top window.

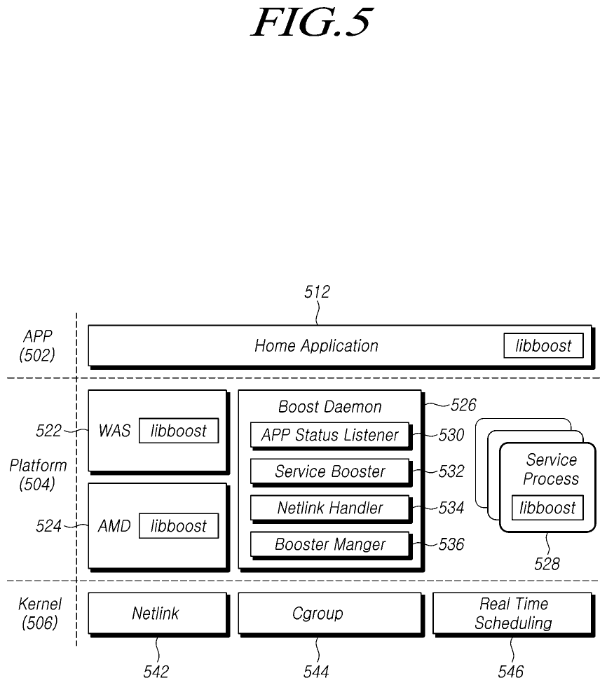

In operations 4020 and 4030, the electronic device 310 may transfer the received user input to the application 430 through a window manager 420. When the user input is transferred, the electronic device 310 (or the application of the electronic device 310) may store an event corresponding to the user input in a memory (e.g., a main queue), and may wait for processing of the corresponding event. According to an embodiment, the window manager 420 may be included in a platform (e.g., the platform 504 of FIG. 5). For example, a separate window manager may be included for each platform.

According to an embodiment, the window manager 420 may manage window(s) displayed on a screen (e.g., a current screen). For example, the window manager 420 may manage a window stack including data of the window(s) displayed on the current screen. The data of the window may include, for example, information about a process of an application corresponding to the corresponding window (e.g., PID information of the process) and/or information about a view displayed in the window. The window stack may sequentially store data from the top window to the lowermost window. As an example, the data of the top window may be stored at the topmost position on the window stack, and the data of the lowermost window may be stored at the lowermost position on the window stack, but is not limited thereto. For example, the reverse is also possible, and various manners are possible.

Meanwhile, the settings of the above-described window and the view displayed on the window may be controlled by the window manager 420. The window manager 420 may provide various types of window and view settings, without being limited to the above-described example, according to a request of an application, a user input, and/or a system setting. For example, a plurality of windows corresponding to a plurality of applications may be arranged in the same layer. For example, a plurality of windows may be allocated to one application, or one window may be allocated to a plurality of applications.

In operation 4040, the electronic device 310 (or, the application 430 of the electronic device 310) may obtain an event corresponding to the user input from a memory (e.g., a main queue). As an example, when a CPU resource is allocated to a thread (e.g., a UI thread or a main thread) that initiates processing of the event corresponding to the user input, the electronic device 310 may obtain the corresponding event from the main queue.

According to an example, the electronic device 310 (or, the UI thread) may trigger a UI display/rendering request (or, a UI drawing (draw) request) for processing the event corresponding to the user input.

In operation 4050, the electronic device 310 (or, the application 430 of the electronic device 310) may perform processing for displaying, on a screen, a user interface (UI) corresponding to the corresponding event. As an example, when a CPU resource is allocated to a thread (e.g., a renderer thread) that performs rendering processing of the corresponding event, the electronic device 310 may perform rendering processing for displaying, on the screen, the UI corresponding to the corresponding event.

According to an example, as illustrated in part (a) of FIG. 4B, when an event of selecting a second application is identified, the electronic device 310 (or, the renderer thread) may perform rendering processing for displaying a user interface 440b (e.g., a button for increasing sound, or a button for decreasing sound) for increasing or decreasing the sound of the content of the second application on a second view of the second window 401b. As illustrated in part (b) of FIG. 4B, the second window 401b corresponding to the application 430 currently selected or executed may be set as the top window before or after the rendering processing.

According to an example, as illustrated in part (a) of FIG. 4C, when an event of selecting a first application is identified, the electronic device 310 (or, the renderer thread) may perform rendering processing for displaying a user interface 440c (e.g., a play button, a fast-forward button, a rewind button) for controlling a playback operation of the content of the first application on a first view of the first window 401c. As illustrated in part (b) of FIG. 4C, the first window 401c corresponding to the application 430 currently selected or executed may be set as the top window before or after the rendering processing.

FIG. 5 is a system architecture diagram for CPU scheduling of an electronic device according to an embodiment of the disclosure.

Referring to FIG. 5, a system for CPU scheduling of the electronic device 310 may include an application 502 (e.g., the application 430 of FIG. 4A), a platform 504, and a kernel 506.

The application 502 may also be referred to as an app (APP or app) and may be associated with a service. The application 502 may include a software program that is executed by a user's selection. According to an example, the application 502 may be executed by a user's selection using at least one external device 320 or remote controller 330. According to an example, the application 502 may be executed based on an OS and may or may not be displayed on the screen of the electronic device 310. The application 502 may provide various services such as media playback. According to an example, the application 502 may include a home application 512 displayed on the screen of the electronic device 310 after cold booting. According to an example, the home application 512 may be an application that provides a UI for at least one of application selection, website search, broadcast channel selection, or external device connection.

The platform 504 may be associated with an OS and may provide an environment for executing the application 502. The platform 504 may access hardware through the kernel 506, and may perform a control group allocation, a control group change or movement, a CPU resource allocation, or a process management operation associated with a service. According to an example, the platform 504 may include a web application service (WAS) 522, an application management daemon (AMD) 524, a boost daemon (or, booster module) 526, and a service process (or, process) 528. According to an example, the platform 504 may include a window manager (e.g., the window manager 420 of FIG. 4A).

The WAS 522 may perform an operation for providing a web-based application service. The AMD 524 may manage execution of the application 502 and a lifecycle of the application 502 (e.g., app create, app resume, app pause, app terminate). When an event corresponding to the lifecycle of the application 502 occurs, the AMD 524 may provide information on a process of the application 502 to the boost daemon 526.

The boost daemon 526 may perform CPU scheduling and/or CPU resource management. According to an example, the boost daemon 526 may include an App Status Listener 530, a Service Booster 532, a Netlink Handler 534, and a Booster Manager 536.

The App Status Listener 530 may receive an event associated with the lifecycle of the application 502. The Service Booster 532 may manage CPU resource allocation of the service process 528. The Netlink Handler 534 may receive an event associated with the lifecycle of a process. The Booster Manager 536 may set a CPU policy (or, CPU scheduling scheme), a control group allocation, determination of a resource allocation ratio, or a CPU resource allocation priority.

The service process 528 may provide functions necessary for the operation of a service (or, application). There may be one or more service processes 528.

The kernel 506 may manage hardware and provide services necessary for the platform 504. The kernel 506 may include a Netlink 542, a Cgroup 544, and a real-time scheduling unit 546.

The Netlink 542 may provide an event (e.g., a process fork event, a process execute event, or a process exit event) associated with the lifecycle of a process of the application 502. The Cgroup 544 may provide a CPU resource distribution function. The real-time scheduling unit 546 may perform real-time scheduling that preempts a CPU resource.

An operation associated with the CPU scheduling of the application 502 may be performed through the boost daemon 526 and the kernel 506 of FIG. 5 as follows.

At a time point when a process of the application 502 is forked, the Netlink 542 of the kernel 506 may provide a process fork event to the boost daemon 526. The boost daemon 526 may receive the process fork event (or, application create event) through the Netlink Handler 534. According to an example, the process fork event may be an event associated with creation of a process of the application 502. For example, the process fork event may be an event indicating a state in which the application 502 is created, a process identifier (PID) of a process of the application 502 is allocated, and a main thread (or, a main task) is created. According to an example, the process execute event (or, application resume/re-execution event) that may be provided by the Netlink 542 may be an event indicating execution (or, execution/resumption of the application) of the process of the application 502 that may occur after the process fork event. According to an example, the process exit event may be an event indicating termination of the process of the application 502 that may occur after the process execute event.

The Netlink Handler 534 may receive the process fork event, and may provide information on the received process fork event to the Service Booster 532. The Service Booster 532 may receive the information on the process fork event from the Netlink Handler 534, and may transfer the received information to the Booster Manager 536 for CPU resource allocation for the process of the application 502.

The Booster Manager 536 may set a CPU policy for the process of the application 502 and may allocate a CPU resource. The process of the application 502 may perform initialization based on the allocated CPU resource. According to an example, the initialization may include a preparation operation (or, a preliminary operation) that needs to be performed to execute the application 502. When the initialization is completed, the process of the application 502 may request the boost daemon 526 to release boosting by calling a boost library (libboost) (or, a resource allocation boosting release API (application programming interface)).

The App Status Listener 530 may receive an app execute/resume event. According to an example, the app execute/resume event may be an event requesting the application 502. The application 502 associated with the app execute/resume event may be, for example, an application providing another service that does not require communication with at least one external device 320 (e.g., an OTT application). According to an example, the app execute event may be received based on a control signal transmitted from the remote controller 330. The control signal transmitted from the remote controller 330 may be, for example, a control signal based on a user's key input on the remote controller 330.

The App Status Listener 530 may provide, to the Booster Manager 536, information indicating that the app execute/resume event has been received. The Booster Manager 536 may determine, based on the received information, that the application 502 associated with the app execute/resume event is to be executed/resumed. In case that the application 502 is executed/resumed, the Booster Manager 536 may recognize the application 502 as a foreground app.

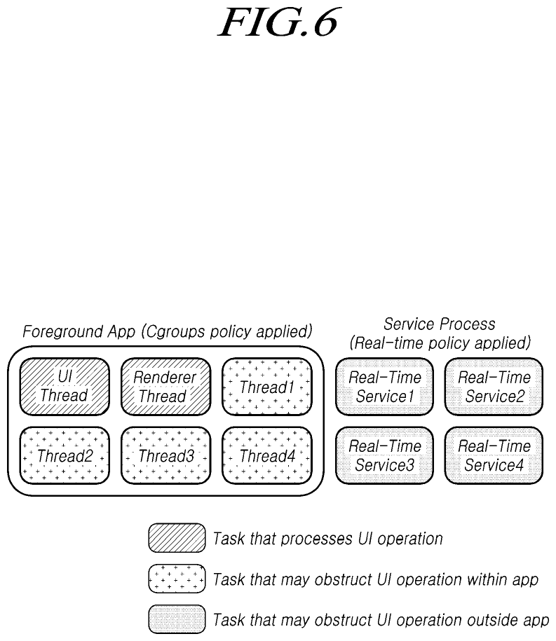

FIG. 6 is a view illustrating an example in which various scheduling schemes are applied to an application according to an embodiment of the disclosure.

Referring to FIG. 6, a CFS scheduling scheme (e.g., the CFS scheduling scheme 210 of FIG. 2) (e.g., a Cgroups policy) may be applied to an application executed in the foreground (foreground app) (or a process of the foreground app).

In case that the Cgroups policy is applied to the foreground app, UI responsiveness may be degraded due to at least one thread belonging to the process of the foreground app and capable of obstructing a UI operation. For example, as illustrated in FIG. 6, the process of the foreground app may include not only at least one thread (e.g., a UI thread, a renderer thread) that processes a task associated with a UI operation, but also at least one thread that processes a task capable of obstructing the UI operation. Accordingly, it is difficult to sufficiently ensure the CPU usage required by at least one thread associated with the UI operation merely by applying the Cgroups policy to the foreground app itself. This is because, since the Cgroups policy is applied to all threads of the foreground app, in case that threads other than the thread associated with the UI operation within the app occupy CPU usage, processing of the thread associated with the UI operation is delayed. As a result, UI responsiveness is degraded.

In case that the Cgroups policy is applied to the foreground app, UI responsiveness may be degraded due to a process external to the foreground app. For example, as illustrated in FIG. 6, a service that plays a media source with high CPU usage, such as an Advanced Television Systems Committee (ATSC) 3.0 service, may be provided together with the foreground app. In this case, for example, the Real-Time scheduling scheme 220 may be applied to the process of the corresponding service. As a result, excessive CPU contention occurs, and it is difficult to sufficiently ensure the CPU usage required for the UI response to the foreground app merely by the Cgroups policy. Such a phenomenon may similarly occur even in case that the system is busy because initialization of the OS is not completed at an early stage of cold booting.

In addition, in case that the Cgroups policy is applied to a plurality of foreground apps, a different priority may be applied for each app. In this case, since another app with a higher priority set may occupy high CPU usage, sufficient CPU resources may not be allocated to a main thread related to a UI operation of a desired app (e.g., a main thread related to a UI operation of an app corresponding to a currently focused window).

Accordingly, there is a need for a method for selecting threads related to a UI operation of an application desired by a user (e.g., an application selected or executed by user input) and applying a separate CPU scheduling scheme to the selected threads. Through this, while maintaining fast cold booting performance, the UI of a desired application can be smoothly provided to the user without degradation of UI responsiveness.

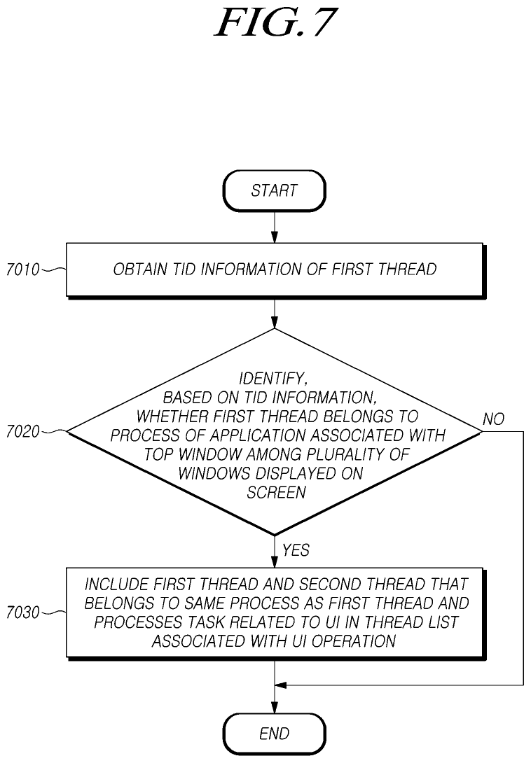

FIG. 7 is a flowchart illustrating an operation of selecting a thread related to a UI operation according to an embodiment of the disclosure.

In the embodiment of FIG. 7, an operation of selecting threads related to a UI operation (UI operation-related thread selecting operation) may be performed by the electronic device 310 (e.g., the booster module 526 of the electronic device 310). For example, the booster module 526 of the electronic device 310 may, in cooperation with an application (e.g., the application 430) and a window manager (e.g., the window manager 420) of the electronic device 310, perform the UI operation-related thread selecting operation. An operation of the electronic device 310 described below may be understood as an operation of the booster module 526 that is controlled by the electronic device 310 or a processor of the electronic device 310.

Referring to FIG. 7, in operation 7010, the electronic device 310 may obtain thread ID (TID) information of a first thread that receives a request for rendering for displaying a UI for an application (hereinafter, referred to as UI rendering).

According to an embodiment, the first thread may be configured to process a task related to rendering for displaying a UI. For example, the first thread may be a thread that receives, from a second thread configured to process a task related to a UI for an application, a request for UI rendering (hereinafter, referred to as a UI rendering request or a UI draw request) and processes a task related to rendering based on the UI rendering request. The UI rendering request may include at least one piece of information necessary for UI rendering.

According to an embodiment, the second thread may be a thread that triggers a UI rendering request (or a UI draw request) for an application. The second thread may, for example, transmit a UI rendering request for an application to the first thread based on a user input. For example, in case that a user input selecting or executing an application (or an event associated with UI rendering corresponding to the user input) is identified, the second thread may transmit a UI rendering request for the corresponding application to the first thread.

According to an embodiment, the first thread and the second thread may belong to a process of the same application. According to an embodiment, the application may be an application executed in the foreground (foreground app).

In the disclosure, the first thread may be referred to as a render thread, a renderer thread, or a UI rendering request thread. In the disclosure, the second thread may be referred to as a UI thread.

According to an embodiment, the electronic device 310 may receive information about the first thread from the application, and obtain the TID information of the first thread from the information about the first thread. The information about the first thread may include the TID information of the first thread and/or at least one piece of additional information associated with the first thread. The TID information of the first thread may indicate the TID of the first thread.

According to an embodiment, the application may identify an event associated with UI rendering based on a user input. For example, in case that the application receives a user input selecting or executing the application (e.g., the remote controller key input or touch input in operation 4010 of FIG. 4A), the application may identify an event associated with UI rendering corresponding to the user input.

According to an embodiment, the application may transmit, to the booster module 526 of the electronic device 310, information about the first thread including the TID information of the first thread, based on the event associated with UI rendering being identified. For example, in response to the event associated with UI rendering being identified, the application may, by calling a rendering API, request UI rendering and transmit, to the booster module 526 of the electronic device 310, information about the first thread including the TID information of the first thread. The rendering API may be an API provided by the window manager.

In operation 7020, the electronic device 310 may identify, based on the TID information of the first thread, whether the first thread belongs to a process of an application associated with a top window among at least one window displayed on a screen.

According to an embodiment, the top window may be a window in which a UI (e.g., the UI 440b of FIG. 4B or the UI 440c of FIG. 4C) corresponding to a user input is displayed on a screen (e.g., a current screen (e.g., the screen 400b of FIG. 4B or the screen 400c of FIG. 4C)). Data of the top window may, for example, be stored at the topmost position on a window stack.

According to an embodiment, the top window may be a window corresponding to a user's application of interest among at least one window displayed on a screen (e.g., a current screen).

According to an embodiment, the top window (or focused window) may be a window arranged at a frontmost position (e.g., arranged closest to the screen) among at least one window (e.g., a first window to a fourth window of FIG. 4b/c) displayed on a screen (e.g., a current screen). For example, the top window may be a second window 401b illustrated in part (b) of FIG. 4b or a first window 401c illustrated in part (b) of FIG. 4c. For a description of the top window, reference may be made to the description of FIGS. 4a to 4c.

According to an embodiment, the electronic device 310 may arrange a corresponding window at the frontmost position based on a request for sending the window to a front (hereinafter, referred to as a focus request) being identified. The focus request may be made based on a user input for selecting or executing an application corresponding to a window.

According to an embodiment, the electronic device 310 may obtain information about a process of an application associated with the top window. As an example, the booster module 526 of the electronic device 310 may receive the information about the process of the application associated with the top window from the window manager. The information about the process of the application associated with the top window may include, for example, PID information indicating a process ID (PID) of the process.

According to an embodiment, the information about the process of the application associated with the top window may be transmitted, for example, by the window manager, based on a change of the top window being identified. For example, the window manager may, in response to a change of the top window being identified, transmit the information about the process of the application associated with the top window to the booster module 526 of the electronic device 310. As an example, the window manager may, whenever a change of the top window is identified, transmit the information about the process of the application associated with the top window to the booster module 526 of the electronic device 310. As an example, the window manager may, whenever a change of the window(s) displayed on the screen (or a change of a window stack) is identified, transmit information about a process of an application associated with the corresponding window(s) (or window stack change information) to the booster module 526 of the electronic device 310. The window stack change information may include, for example, information about a process of an application associated with changed window(s) on the window stack.

According to an embodiment, the electronic device 310 may compare TID(s) of thread(s) belonging to the process of the application associated with the top window identified based on the PID information transmitted from the window manager with a TID of the first thread identified by TID information transmitted from the application, to identify whether the first thread belongs to the process of the application associated with the top window. For example, when one of the TID(s) of the thread(s) belonging to the process of the application associated with the top window is identical to the TID of the first thread, the electronic device 310 may identify that the first thread belongs to the process of the application associated with the top window. For example, when any one of the TID(s) of the thread(s) belonging to the process of the application associated with the top window does not match the TID of the first thread, the electronic device 310 may identify that the first thread does not belong to the process of the application associated with the top window.

According to an embodiment, when an application is executed or re-executed, the booster module 526 of the electronic device 310 may obtain a thread list including TID(s) of thread(s) belonging to a process of the corresponding application from the AMD 524.

In operation 7030, the electronic device 310 may, based on the first thread being identified as belonging to the process of the application associated with the top window, include the first thread and a second thread which belongs to the same process as the first thread and is configured to process a task related to a UI in a thread list associated with a UI operation of the application (hereinafter, referred to as a UI thread list).

According to an embodiment, the threads included in the UI thread list may have a scheduling setting different from at least one thread which belongs to the same process and is not included in the UI thread list applied thereto. According to an embodiment, the threads included in the UI thread list may have a priority adjustment different from at least one thread which belongs to the same process and is not included in the UI thread list applied thereto. Through this, responsiveness of the UI operation processed by the threads included in the UI thread list may be enhanced.

For example, the threads included in the UI thread list may have a scheduling scheme (or scheduling policy) different from at least one thread which belongs to the same process and is not included in the UI thread list applied thereto. As an example, the threads included in the UI thread list may have an RT scheduling scheme (RT policy) applied thereto, and other threads of the corresponding process not included in the UI thread list may have a CFS scheduling scheme (e.g., Cgroups policy) applied thereto.

For example, the threads included in the UI thread list may be set to have a higher priority than at least one thread which belongs to the same process and is not included in the UI thread list. As an example, both the threads included in the UI thread list and other threads of the corresponding process not included in the UI thread list may have a CFS scheduling scheme (e.g., Cgroups policy) applied thereto, but the threads included in the UI thread list may be set to have a higher priority than the other threads of the corresponding process not included in the UI thread list.

According to an embodiment, the electronic device 310 may, in response to the first thread being identified as belonging to the process of the application associated with the top window, include the first thread in the UI thread list of the application. Thereafter, the electronic device 310 may identify a process to which the first thread belongs, identify a second thread configured to process a task related to a UI among the thread(s) belonging to the corresponding process, and include the second thread in the UI thread list of the application. Through this, the first thread and the second thread that affect UI responsiveness may be included together in the UI thread list.

According to an embodiment, the electronic device 310 may identify, as the second thread, a thread having a TID identical to the process ID (PID) of the process among threads included in the process to which the first thread belongs. This scheme may be applied when the first thread (UI thread) corresponds to a main thread of the application. This is because the main thread is a thread that is created first when the process is created, and is set to have an ID identical to the ID of the process.

According to an embodiment, the electronic device 310 may identify, as the second thread, a thread having a name identical to the name of the process among threads included in the process to which the first thread belongs. This scheme may be applied when the first thread (UI thread) corresponds to a main thread of the application. This is because the main thread is a thread that is created first when the process is created, and is set to have a name identical to the name of the process.

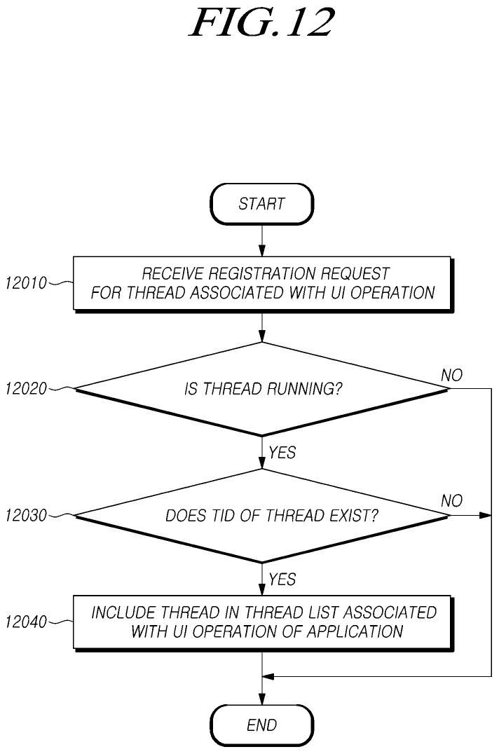

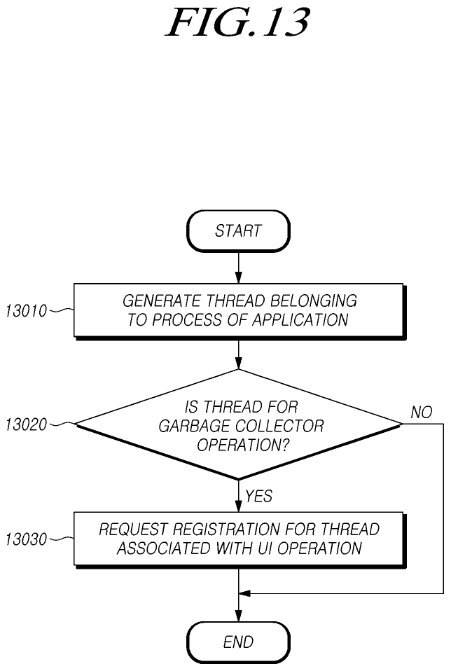

According to an embodiment, the electronic device 310 may identify, as the first thread, a thread having a thread ID registered as the first thread (UI thread) among threads included in the process to which the first thread belongs. This scheme may be applied when the first thread (UI thread) does not correspond to a main thread of the application. As an example, a registration API capable of registering a thread (e.g., the first thread) in the application may be provided, and the application (or the main thread of the application) may register a thread (e.g., the first thread) by calling the registration API. Information of a thread registered through the registration API may be a TID of the corresponding thread (e.g., the first thread). The registration of the thread will be exemplarily described below with reference to FIGS. 12 and 13.

As described above, the thread selection operation of the disclosure does not include all threads associated with a UI operation in the UI thread list, but includes only threads associated with a UI operation belonging to a process of an application associated with the top window (or focused window) in the UI thread list, thereby allowing only threads that substantially affect UI responsiveness to be selected and separately managed.

On the other hand, depending on an implementation structure of an application, in addition to the above-described first thread (renderer thread) and second thread (UI thread), there may be a thread having a dependency on the renderer thread and/or the UI thread. That a thread has a dependency (or dependency relationship) on another thread may include a case where, if processing of one thread is not completed, processing of another thread cannot be completed.

For example, in the case of a specific application (e.g., an OTT app), since a UI thread waits for completion of processing of a worker thread (worker thread) created in the corresponding application, the worker thread and the UI thread have a dependency (e.g., the processing of the UI thread is dependent on the processing of the worker thread). In this case, the corresponding worker thread also needs to have its priority adjusted together with the UI thread in order to obtain an improvement effect of UI responsiveness.

For example, in the case of a specific application (e.g., a home app), since the entire process may stop if processing of a thread associated with a garbage collection operation (e.g., a stdout thread) created in the corresponding application is not completed, the corresponding thread and the UI thread have a dependency (e.g., the processing of the UI thread is dependent on the processing of the corresponding thread). In this case, the corresponding thread also needs to have its priority adjusted together with the UI thread in order to obtain an improvement effect of UI responsiveness.

According to an embodiment, the electronic device 310 may provide a registration API for registering, upon creation of a thread (e.g., a worker thread) having a dependency on UI rendering, the corresponding thread to a process of an application (or to a UI thread list of an application). In this case, the electronic device 310 (or a main thread of the electronic device 310) may, upon creation of a thread having a dependency on UI rendering, register the corresponding thread by calling the corresponding registration API with the TID of the corresponding thread as a parameter. A thread registered in this way may be identified together when a renderer thread is identified (e.g., a renderer thread to be included in a thread list is identified by operation 7020). The registration of the thread will be exemplarily described below with reference to FIGS. 12 and 13.

According to an embodiment, based on identifying that the first thread (UI thread) belongs to the process of the application associated with the top window, the electronic device 310 may include, in the thread list associated with the UI operation of the application, a third thread having a dependency on the first thread and/or the second thread (renderer thread), together with the first thread and the second thread.

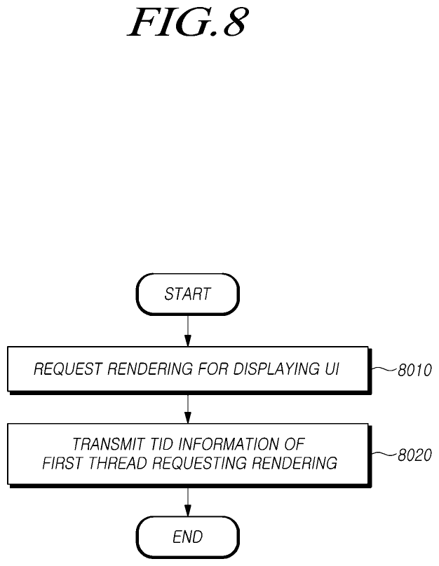

FIG. 8 is a flowchart illustrating an operation of an application for selecting a thread related to a UI operation according to an embodiment of the disclosure.

For the description of operations 8010 and 8020 of FIG. 8, the description of operation 7010 of FIG. 7 may be referred to. Accordingly, a redundant description thereof will be omitted.

Referring to FIG. 8, in operation 8010, an application (e.g., the application 430) may request rendering (UI rendering) for displaying a UI. The rendering request API may be, for example, an API provided by a window manager (e.g., the window manager 420).

According to an embodiment, the application may call the rendering request API to request UI rendering. For example, when a user input selecting or executing the corresponding application is identified, the application may call the rendering request API to request UI rendering. As an example, when a user input selecting or executing the corresponding application is identified, the second thread (UI thread) of the application may call the rendering request API to request UI rendering to the first thread (renderer thread). In response to the call of the application, the rendering request API may transmit, to the application or a booster module (e.g., the booster module 561), TID information of the first thread (renderer thread) which has been requested for the UI rendering.

In operation 8020, the application (or the rendering request API) may transmit, to the booster module 561, the TID information of the first thread (renderer thread) which has been requested for the UI rendering.

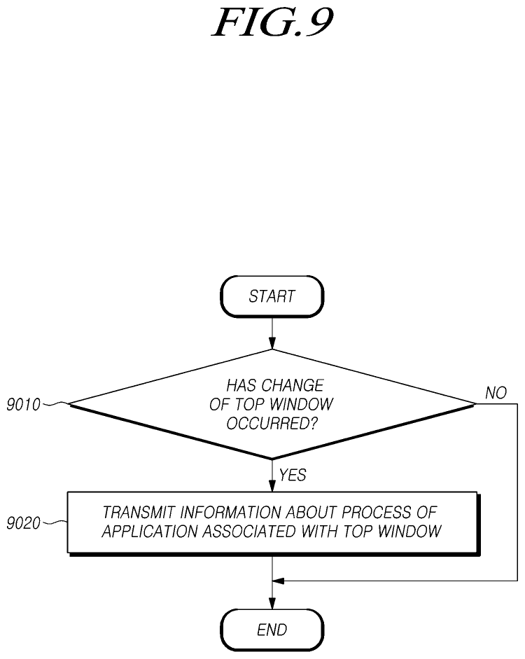

FIG. 9 is a flowchart illustrating an operation of a window manager for selecting a thread related to a UI operation according to an embodiment of the disclosure.

For the description of operations 9010 and 9020 of FIG. 9, the description of operation 7020 of FIG. 7 may be referred to. Accordingly, a redundant description thereof will be omitted.

Referring to FIG. 9, in operation 9010, the window manager (e.g., the window manager 420) may identify whether a change of the top window occurs.

According to an embodiment, the change of the top window may occur based on a user input selecting an application (e.g., the application 430). For example, in a state in which the second window 401b corresponding to the second application is set as the top window as illustrated in portion (b) of FIG. 4B, when a user input selecting the first application is selected as illustrated in portion (b) of FIG. 4C, the top window may be changed from the second window 401b to the first window 401c. A UI corresponding to the user input may be drawn on the top window. The change of the top window may cause a change of the window stack.

In operation 9020, when it is identified that the change of the top window occurs, the window manager may transmit, to the booster module (e.g., the booster module 561), information about the process of the application associated with the top window. The information about the process of the application associated with the top window may include, for example, PID information indicating the PID of the process of the application associated with the top window.

According to an embodiment, the window manager may transmit, to the booster module 561, window stack change information including information about the process of the application associated with the top window.

According to an embodiment, the window stack change information may include, together with the information about the process of the application associated with the top window, information about processes of the windows included in the window stack (e.g., PID information).

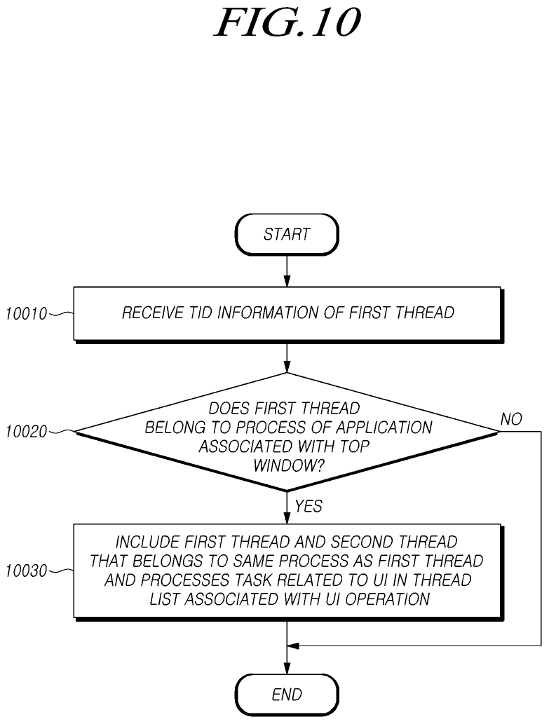

FIG. 10 is a flowchart illustrating an operation of a booster module for selecting a thread related to a UI operation according to an embodiment of the disclosure.

For the description of operations 10010 to 10030 of FIG. 10, the description of operations 7010 to 7030 of FIG. 7 may be referred to. Accordingly, a redundant description thereof will be omitted.

In operation 10010, the booster module (e.g., the booster module 561) may receive the TID information of the first thread (renderer thread) which has been requested for the rendering. For the description of operation 10010 of FIG. 10, the description of operation 7010 of FIG. 7 may be referred to. Accordingly, a redundant description thereof will be omitted.

According to an embodiment, the booster module 561 may receive the TID information of the first thread which has been requested for the rendering from the application (e.g., the application 430).

According to an embodiment, the booster module 561 may receive the PID information of the process of the application associated with the top window from the window manager (e.g., the window manager 420). As an example, after the TID information of the first thread is received or before the TID information of the first thread is received, the booster module 561 may receive the PID information of the process of the application associated with the top window from the window manager.

In operation 10020, the booster module 561 may identify whether the first thread belongs to the process of the application associated with the top window. For the description of operation 10020 of FIG. 10, the description of operation 7020 of FIG. 7 may be referred to. Accordingly, a redundant description thereof will be omitted.

According to an embodiment, based on the received TID information and PID information, the booster module 561 may identify whether the first thread belongs to the process of the application associated with the top window.

In operation 10030, when the first thread is identified as belonging to the process of the application associated with the top window, the booster module 561 may include the first thread and a second thread (UI thread) that belongs to a same process as the first thread and processes a UI-related task in a thread list associated with a UI operation (UI thread list). For the description of operation 10030 of FIG. 10, the description of operation 7030 of FIG. 7 may be referred to. Accordingly, a redundant description thereof will be omitted.

Meanwhile, when the first thread is not identified as belonging to the process of the application associated with the top window, the booster module 561 does not include the first thread and the second thread (UI thread) in the UI thread list. That is, the first thread and the second thread are not set as threads whose priority is adjusted separately from other threads within the corresponding process. This is because the application of the process to which the first thread and the second thread belong does not correspond to the application that the user is currently interested in (e.g., the application associated with the UI response).

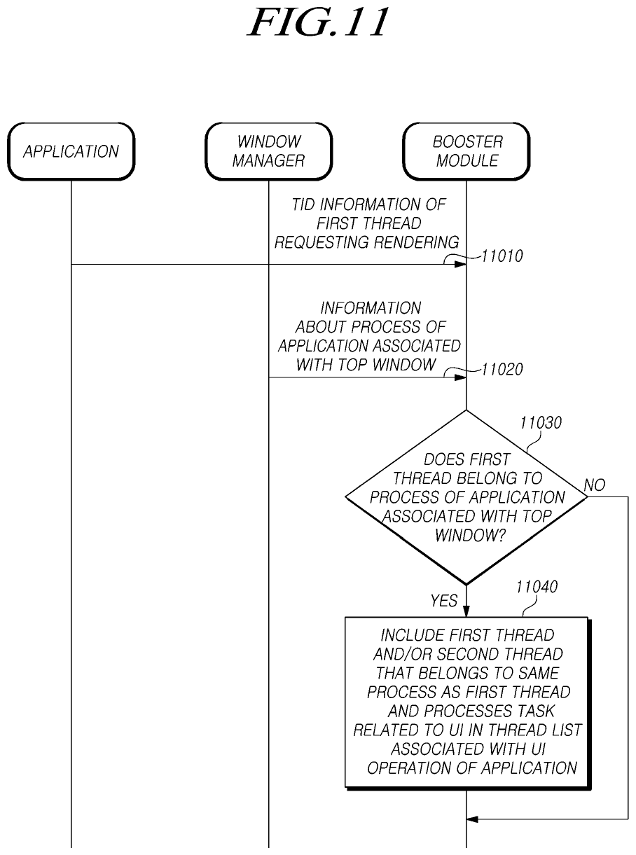

FIG. 11 is a signal flow diagram illustrating a procedure of selecting a thread related to a UI operation according to an embodiment of the disclosure.

In operation 11010, an application (e.g., the application 430) may transmit the TID information of the rendering request thread (the first thread) to a booster module (e.g., the booster module 561). For the description of operation 11010, the description of operation 7010 of FIG. 7, operations 8010/8020 of FIG. 8, and operation 10010 of FIG. 10 may be referred to. Accordingly, a redundant description thereof will be omitted.

In operation 11020, a window manager (e.g., the window manager 420) may transmit information about the process of the application associated with the top window to the booster module. Operation 11020 may be performed before operation 11010, or may be performed in parallel together with operation 11010. For the description of operation 11020, the description of operations 9010/9020 of FIG. 9 may be referred to. Accordingly, a redundant description thereof will be omitted.

In operation 11030, the booster module may identify whether the first thread belongs to the process of the application associated with the top window. For operation 11030, the description of operation 7020 of FIG. 7 or operation 10020 of FIG. 10 may be referred to. Accordingly, a redundant description thereof will be omitted.

In operation 11040, when the first thread is identified as belonging to the process of the application associated with the top window, the booster module may include the first thread and/or a second thread that belongs to a same process as the first thread and processes a UI-related task in a thread list associated with a UI operation of the application (UI thread list). For operation 11040, the description of operation 7030 of FIG. 7 or operation 10030 of FIG. 10 may be referred to. Accordingly, a redundant description thereof will be omitted.

FIG. 12 is a flowchart illustrating an operation of registering a thread associated with a UI operation according to an embodiment of the disclosure.

In the embodiment of FIG. 12, the operation of registering a thread associated with a UI operation (UI-associated thread registration operation) may be performed, for example, by the electronic device 310 (e.g., the booster module 526 of the electronic device 310). The operation of the electronic device 310 described below may be understood as an operation of the booster module 526 controlled by the electronic device 310 or a processor of the electronic device 310.

Referring to FIG. 12, in operation 12010, the electronic device 310 may receive a registration request for a thread associated with a UI operation (UI-associated thread). The thread associated with the UI operation may be the first thread (renderer thread), the second thread (UI thread), or a thread having a dependency on the first thread or the second thread (UI thread).

According to an embodiment, the electronic device 310 may receive a registration request for the thread associated with the UI operation from an application (e.g., the application 430). As an example, a main thread (e.g., the UI thread) of the application may, by calling a UI registration request API for the UI-associated thread, transmit a registration request for the UI-associated thread including the TID information of the UI-associated thread to the booster module 526.

In operation 12020, the electronic device 310 may identify whether the UI-associated thread is being executed.

According to an embodiment, the electronic device 310 may identify whether the UI-associated thread having the TID included in the registration request is being executed.

When the UI-associated thread is identified as not being executed, the electronic device 310 does not proceed with an additional procedure for registering the UI-associated thread. This is because, when the UI-associated thread is not being executed (or when the application of the UI-associated thread has terminated), there is no need to set the corresponding thread as a thread whose priority is adjusted separately.

In operation 12030, when the UI-associated thread is identified as being executed, the electronic device 310 may identify whether the TID of the UI-associated thread exists.

According to an embodiment, the electronic device 310 may identify whether the TID of the UI-associated thread exists in a system (e.g., the system for CPU scheduling of FIG. 5).

When the TID of the UI-associated thread is identified as not existing, the electronic device 310 does not proceed with an additional procedure for registering the UI-associated thread. This is because, when the TID of the UI-associated thread does not exist in the system, since the application of the process to which the corresponding thread belongs is in a state of not being executed (or, re-executed), there is no need to set the corresponding thread as a thread whose priority is adjusted separately.

In operation 12040, when the TID of the UI-associated thread is identified as existing, the electronic device 310 may include the UI-associated thread in a thread list associated with a UI operation of the application (UI thread list). According to an embodiment, the electronic device 310 may register the TID of the UI-associated thread in the UI thread list. Through this, the UI-associated thread may be set as a thread whose priority is adjusted separately, and thereafter, the priority may be adjusted together with the first thread (renderer thread) and the second thread (UI thread).

According to an embodiment, a scheduling setting different from at least one thread that belongs to a same process and is not included in the UI thread list may be applied to threads included in the UI thread list. According to an embodiment, a priority adjustment different from at least one thread that belongs to a same process and is not included in the UI thread list may be applied to threads included in the UI thread list. Through this, the responsiveness of the UI operation processed by the threads included in the UI thread list may be improved.

For example, a scheduling scheme (or, scheduling policy) different from at least one thread that belongs to a same process and is not included in the UI thread list may be applied to threads included in the UI thread list. As an example, the RT scheduling scheme (RT policy) may be applied to threads included in the UI thread list, and the CFS scheduling scheme (e.g., Cgroups policy) may be applied to other threads of the corresponding process that are not included in the UI thread list.

For example, the threads included in the UI thread list may be set to have a higher priority than at least one thread that belongs to the same process and is not included in the UI thread list. As an example, although the CFS scheduling scheme (e.g., the Cgroups policy) is applied to both the threads included in the UI thread list and the other threads of the corresponding process that are not included in the UI thread list, the threads included in the UI thread list may be set to have a higher priority than the other threads of the corresponding process that are not included in the UI thread list.

FIG. 13 is a flowchart illustrating an operation of requesting registration of a thread associated with a UI operation according to an embodiment of the disclosure.

In the embodiment of FIG. 13, the operation of requesting registration of a thread associated with a UI operation (UI-associated thread registration request operation) may be performed, for example, by the electronic device 310 (e.g., an application of the electronic device 310). The operation of the electronic device 310 described below may be understood as an operation of the application controlled by the electronic device 310 or the processor of the electronic device 310.

In operation 13010, the electronic device 310 may create a thread belonging to a process of the application.

According to an embodiment, the electronic device 310 may identify whether the corresponding thread is a thread associated with a UI operation. For example, as in operation 13020, the electronic device 310 may identify whether the corresponding thread is a thread for a Garbage Collect operation (Garbage Collect operation thread). The Garbage Collect operation thread may be, for example, a thread that performs a function of periodically inspecting a memory space allocated by the application and releasing memory that is no longer used. Since the entire process may stop if processing of the Garbage Collect operation thread is not completed, the Garbage Collect operation thread may be a thread having a dependency on the UI thread (second thread).

According to an embodiment, when the corresponding thread is identified as a thread associated with a UI operation, the electronic device 310 may request registration of the thread associated with the UI operation (UI-associated thread registration). For example, as in operation 13030, when the corresponding thread is identified as the Garbage Collect operation thread, the electronic device 310 may request UI-associated thread registration of the corresponding thread. As an example, the electronic device 310 may request UI-associated thread registration of the corresponding thread by calling a registration API.

According to an embodiment, when a registration request of a thread associated with a UI operation (UI-associated thread registration request) is received, the electronic device 310 may, for example, perform the UI-associated thread registration operation of FIG. 12 to include (or register) the corresponding thread in the UI thread list. For a description of the UI-associated thread registration operation for the corresponding thread, reference may be made to the description of FIG. 12. A redundant description thereof is omitted.

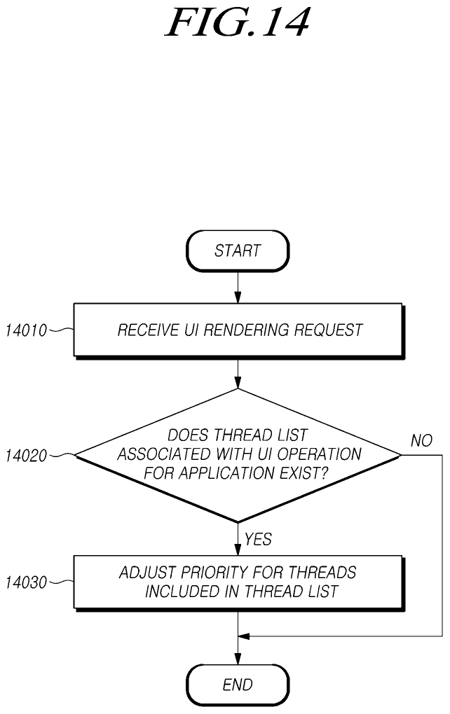

FIG. 14 is a flowchart illustrating an operation of managing a thread list associated with a UI operation according to an embodiment of the disclosure.

In the embodiment of FIG. 14, the operation of managing a thread list associated with a UI operation (UI thread list management operation) may be performed, for example, by the electronic device 310 (e.g., the booster module 526 of the electronic device 310). The operation of the electronic device 310 described below may be understood as an operation of the booster module 526 controlled by the electronic device 310 or the processor of the electronic device 310.

In operation 14010, the electronic device 310 may receive a UI rendering request for an application. According to an embodiment, the booster module 526 of the electronic device 310 may receive a UI rendering request from the application (or a UI thread of the application). The UI rendering request may be generated based on a user input that selects or executes the corresponding application.

In operation 14020, the electronic device 310 may identify whether a thread list associated with a UI operation (UI thread list) for the corresponding application exists.

In operation 14030, when it is identified that the UI thread list for the corresponding application exists, the electronic device 310 may adjust priorities of the threads included in the UI thread list. The threads included in the UI thread list may include, for example, the first thread (renderer thread), the second thread (UI thread), and/or at least one thread having a dependency on the first thread or the second thread.

According to an embodiment, the electronic device 310 may, before or after operation 14020 is performed, identify whether a window corresponding to the corresponding application corresponds to a top window. When the window corresponding to the corresponding application corresponds to the top window and it is identified that the UI thread list for the corresponding application exists, the electronic device 310 may adjust priorities of the threads included in the UI thread list.

According to an embodiment, a scheduling setting different from that of at least one thread that belongs to the same process and is not included in the UI thread list may be applied to the threads included in the UI thread list. According to an embodiment, a priority adjustment different from that of at least one thread that belongs to the same process and is not included in the UI thread list may be applied to the threads included in the UI thread list. Through this, responsiveness of a UI operation processed by the threads included in the UI thread list may be enhanced.

For example, a scheduling scheme (or scheduling policy) different from that of at least one thread that belongs to the same process and is not included in the UI thread list may be applied to the threads included in the UI thread list. As an example, the RT scheduling scheme (RT policy) may be applied to the threads included in the UI thread list, and the CFS scheduling scheme (e.g., the Cgroups policy) may be applied to the other threads of the corresponding process that are not included in the UI thread list.

For example, the threads included in the UI thread list may be set to have a higher priority than at least one thread that belongs to the same process and is not included in the UI thread list. As an example, although the CFS scheduling scheme (e.g., the Cgroups policy) is applied to both the threads included in the UI thread list and the other threads of the corresponding process that are not included in the UI thread list, the threads included in the UI thread list may be set to have a higher priority than the other threads of the corresponding process that are not included in the UI thread list.

According to an embodiment, the electronic device 310 may perform a UI operation using a CPU resource allocated based on the adjusted priority. Through this, UI responsiveness may be improved.

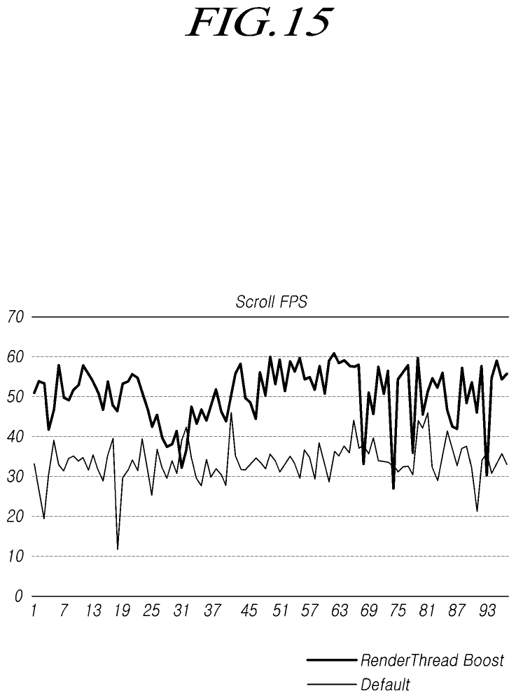

FIG. 15 is a view illustrating a UI responsiveness improvement effect according to an embodiment of the disclosure.

A thin solid line in FIG. 15 illustrates a first result obtained by measuring UI responsiveness (e.g., FPS performance) in a case where the procedure of selecting a thread associated with a UI operation of the disclosure is not performed. Referring to the first result, it can be confirmed that the UI thread does not sufficiently secure CPU usage due to CPU contention, and the average FPS drops to 33 FPS.

A thick solid line in FIG. 15 illustrates a second result obtained by measuring UI responsiveness (e.g., FPS performance) in a case where the procedure of selecting a thread associated with a UI operation of the disclosure is performed. For example, the second result may be a result of measuring UI responsiveness in a state where the render thread (renderer thread) is included in the UI thread list together with the UI thread and the priority is adjusted/boosted. Referring to the second result, it can be confirmed that the UI thread sufficiently secures CPU usage, and the average FPS is improved to 51 FPS.

FIG. 16 is a block configuration diagram of an electronic device according to an embodiment of the disclosure.

Referring to FIG. 16, the electronic device 310 may include a processor 1602, a memory 1604, a display 1606, a first communication interface 1608, and a second communication interface 1610. According to an example, the electronic device 310 may include an additional component (e.g., an audio output unit) in addition to the illustrated components, or may omit at least one of the illustrated components.

According to an example, the memory 1604 may store various pieces of information or data associated with operations of the electronic device 310, and may store at least one program.

According to an example, the display 1606 may perform various display operations according to the functions of the electronic device 310. For example, the display 1606 may display at least one of various service information, media information, text information, or broadcast information according to execution of an application. According to an example, the display 1606 may display a UI corresponding to a user input.

According to an example, the first communication interface 1608 may perform wired or wireless communication with at least one external device 320. For example, the first communication interface 1608 may perform wired communication with the at least one external device 320 through a cable, or may perform wireless communication based on Wi-Fi, Bluetooth, or other wireless communication technologies.

According to an example, the second communication interface 1610 may perform communication with a remote controller. For example, IR communication or RF communication may be performed with at least one external device 320.

According to an example, the processor 1602 is electrically connected with each of the memory 1604, the display 1606, the first communication interface 1608, and the second communication interface 1610, and may execute at least one instruction of the program stored in the memory 1604. The processor 1602 may be one or more, and may perform the operations of the electronic device 310 described above. For example, the at least one processor 1602 includes processing circuitry and may perform at least one of the following operations, individually and/or collectively.

According to an embodiment, the at least one processor 1602 may obtain thread ID (TID) information of a first thread configured to process a task related to rendering for displaying a user interface (UI).

According to an embodiment, the at least one processor 1602 may identify, based on the TID information, whether the first thread belongs to a process of an application associated with a top window among at least one window displayed on a screen.

According to an embodiment, the at least one processor 1602 may, based on the first thread being identified as belonging to the process of the application associated with the top window, include the first thread and a second thread which belongs to the same process as the first thread and is configured to process a task related to the UI in a thread list associated with a UI operation of the application.

According to an embodiment, the threads included in the thread list associated with the UI operation may be configured such that a scheduling setting different from at least one thread which belongs to the process and is not included in the thread list associated with the UI operation is applied thereto.

According to an embodiment, to obtain the TID information of the first thread, the at least one processor 1602 may receive, from the application, the TID information of the first thread for which rendering for displaying the UI has been requested. The application may request rendering for displaying the UI based on a user input for selecting or executing the application.

According to an embodiment, the at least one processor 1602 may, in response to being identified that a change of the top window has occurred, receive, from a window manager, process information about the process of the application associated with the top window. The process information may include PID information indicating a process ID (PID) of the process.

According to an embodiment, the at least one processor 1602 may compare TIDs of threads belonging to the process identified by the PID information with the TID of the first thread identified by the TID information, to identify whether the first thread belongs to the process of the application associated with the top window.

According to an embodiment, the at least one processor 1602 may identify, among threads included in the process, a thread having a TID identical to a PID of the process as the second thread.

According to an embodiment, the at least one processor 1602 may identify, among threads included in the process, a thread having a name identical to a name of the process as the second thread.

According to an embodiment, to include the first thread and the second thread in the thread list associated with the UI operation, the at least one processor 1602 may: in response to the first thread being identified as belonging to the process of the application associated with the top window, include the first thread in the thread list associated with the UI operation, identify the process to which the first thread belongs, identify the second thread among threads included in the process, and include the second thread in the thread list associated with the UI operation.

According to an embodiment, the at least one processor 1602 may be configured to: identify at least one third thread having a dependency on at least one of the first thread or the second thread, and include the third thread in the thread list associated with the UI operation.

According to an embodiment, the threads included in the thread list associated with the UI operation may have a real-time (RT) scheduling scheme applied thereto, and at least one thread which is not included in the thread list associated with the UI operation may have a completely fair scheduler (CFS) scheduling scheme applied thereto.

According to an embodiment, the threads included in the thread list associated with the UI operation may be set to have a higher priority than at least one thread which is not included in the thread list associated with the UI operation.

According to an embodiment, a method of an electronic device may include obtaining thread ID (TID) information of a first thread configured to process a task related to rendering for displaying a user interface (UI).

According to an embodiment, the method of the electronic device may include identifying, based on the TID information, whether the first thread belongs to a process of an application associated with a top window among at least one window displayed on a screen.

According to an embodiment, the method of the electronic device may include, based on the first thread being identified as belonging to the process of the application associated with the top window, including the first thread and a second thread which belongs to the same process as the first thread and is configured to process a task related to the UI in a thread list associated with a UI operation of the application.

According to an embodiment, a scheduling setting different from at least one thread which belongs to the process and is not included in the thread list associated with the UI operation may be applied to threads included in the thread list associated with the UI operation.

According to an embodiment, the obtaining of the TID information of the first thread may include: receiving, from the application, the TID information of the first thread for which rendering for displaying the UI has been requested. The application may request rendering for displaying the UI based on a user input for selecting or executing the application.

According to an embodiment, the method of the electronic device includes: in response to being identified that a change of the top window has occurred, receiving, from a window manager, process information about the process of the application associated with the top window, wherein the process information may include PID information indicating a process ID (PID) of the process.

According to an embodiment, the identifying of whether the first thread belongs to the process of the application associated with the top window may include: comparing TIDs of threads belonging to the process identified by the PID information with the TID of the first thread identified by the TID information, to identify whether the first thread belongs to the process of the application associated with the top window.

According to an embodiment, the at least one method may include: identifying, among threads included in the process, a thread having a TID identical to a PID of the process as the second thread.

According to an embodiment, the at least one method may include: identifying, among threads included in the process, a thread having a name identical to a name of the process as the second thread.

According to an embodiment, the including of the first thread and the second thread in the thread list associated with the UI operation may include: in response to the first thread being identified as belonging to the process of the application associated with the top window, including the first thread in the thread list associated with the UI operation; identifying the process to which the first thread belongs; identifying the second thread among threads included in the process; and including the second thread in the thread list associated with the UI operation.

According to an embodiment, the at least one method may include: identifying at least one third thread having a dependency on at least one of the first thread or the second thread; and including the third thread in the thread list associated with the UI operation.

According to an embodiment, a real-time (RT) scheduling scheme may be applied to threads included in the thread list associated with the UI operation, and a completely fair scheduler (CFS) scheduling scheme may be applied to at least one thread which is not included in the thread list associated with the UI operation.

According to an embodiment, threads included in the thread list associated with the UI operation may be set to have a higher priority than at least one thread which is not included in the thread list associated with the UI operation.

An electronic device 310 according to various embodiments disclosed in the disclosure may be one of various types of devices. The electronic device 310 may include, for example, a portable communication device (e.g., a smartphone), a computer device, a portable multimedia device, a portable medical device, a camera, a wearable device, or a home appliance device. The electronic device 310 according to an embodiment of the disclosure is not limited to the devices described above.

Various embodiments of the disclosure and the terms used therein are not intended to limit the technical features described in the disclosure to specific embodiments, and should be understood to include various modifications, equivalents, or alternatives of the corresponding embodiments. With regard to the description of the drawings, similar reference numerals may be used for similar or related components. A singular form of a noun corresponding to an item may include one or a plurality of the items unless clearly indicated otherwise in the relevant context. In the disclosure, each of phrases such as “A or B,” “at least one of A and B,” “at least one of A or B,” “A, B, or C,” “at least one of A, B, and C,” and “at least one of A, B, or C” may include any one of, or all possible combinations of, the items listed together in a corresponding phrase among the phrases. Terms such as “1st,” “2nd,” or “first,” or “second” may be used merely to distinguish a corresponding component from another corresponding component, and do not limit the corresponding components in another aspect (e.g., importance or order). When a certain (e.g., first) component is referred to, with or without the term “functionally” or “communicatively,” as “coupled” or “connected” to another (e.g., second) component, it means that the certain component may be connected to the other component directly (e.g., by wire), wirelessly, or via a third component.

The term “module” used in various embodiments of the disclosure may include a unit implemented in hardware, software, or firmware, and may be used interchangeably with terms such as, for example, logic, logic block, part, or circuit. A module may be an integrally configured part or a minimum unit of the part or a part thereof that performs one or more functions. For example, according to an embodiment, a module may be implemented in the form of an application-specific integrated circuit (ASIC).

According to various embodiments, each component (e.g., a module or a program) of the above-described components may include a single entity or a plurality of entities, and some of the plurality of entities may be separately disposed in another component. According to various embodiments, one or more components or operations among the above-described corresponding components may be omitted, or one or more other components or operations may be added. Alternatively or additionally, a plurality of components (e.g., modules or programs) may be integrated into a single component. In such a case, the integrated component may perform one or more functions of each component of the plurality of components in a manner identical or similar to a manner in which the corresponding component among the plurality of components performs the functions prior to the integration. According to various embodiments, operations performed by a module, a program, or another component may be executed sequentially, in parallel, repetitively, or heuristically, or one or more of the operations may be executed in a different order, or omitted, or one or more other operations may be added.

1. An electronic device comprising:
a memory to store at least one program; and
at least one processor, electrically connectable with the memory, configured to execute at least one instruction of the at least one program stored in the memory,
wherein the at least one processor is configured to:
obtain thread ID (TID) information of a first thread configured to process a task related to rendering of a user interface (UI) to be displayed,
identify, based on the TID information, whether the first thread belongs to a process of an application associated with a top window among at least one window displayed on a screen, and
include in a thread list the first thread and a second thread that belongs to a same process as the first thread and that is configured to process a task related to the UI based on the first thread being identified as belonging to the process of the application associated with the top window, the thread list being associated with a UI operation of the application,
wherein threads included in the thread list including the first thread and the second thread that are associated with the UI operation are configured such that a scheduling setting different from at least one thread that belongs to the process and is not included in the thread list associated with the UI operation is enabled to be applied.

2. The electronic device of claim 1, wherein, to obtain the TID information of the first thread, the at least one processor is configured to:
receive, from the application, the TID information of the first thread for which the rendering for displaying the UI is requested,
wherein the application requests the rendering for displaying the UI based on a user input that selects or executes the application.

3. The electronic device of claim 1, wherein the at least one processor is configured to:
receive, from a window manager, based on identifying that a change of the top window occurs, process information about the process of the application associated with the top window,
wherein the process information includes PID information indicating a process ID (PID) of the process.

4. The electronic device of claim 3, wherein the at least one processor is configured to:
identify whether the first thread belongs to the process of the application associated with the top window by comparing TIDs of threads belonging to the process identified by the PID information with the TID of the first thread identified by the TID information.

5. The electronic device of claim 3, wherein the at least one processor is configured to:
identify, among threads included in the process, a thread having a TID identical to the PID of the process as the second thread.

6. The electronic device of claim 3, wherein the at least one processor is configured to:
identify, among threads included in the process, a thread having a name identical to a name of the process as the second thread.

7. The electronic device of claim 1, wherein, to include the first thread and the second thread in the thread list associated with the UI operation, the at least one processor is configured to:
include, based on the first thread being identified as belonging to the process of the application associated with the top window, the first thread in the thread list associated with the UI operation,
identify the process to which the first thread belongs,
identify the second thread among threads included in the process, and
include the second thread in the thread list associated with the UI operation.

8. The electronic device of claim 1, wherein the at least one processor is configured to:
identify at least one third thread having a dependency with at least one of the first thread or the second thread, and
include the at least one third thread in the thread list associated with the UI operation.

9. The electronic device of claim 1, wherein a real-time (RT) scheduling scheme is applied to the threads included in the thread list associated with the UI operation, and a completely fair scheduler (CFS) scheduling scheme is applied to at least one thread that is not included in the thread list associated with the UI operation.

10. The electronic device of claim 1, wherein the threads included in the thread list associated with the UI operation are set with a higher priority than at least one thread that is not included in the thread list associated with the UI operation.

11. A method of an electronic device, the method comprising:
obtaining thread ID (TID) information of a first thread configured to process a task related to rendering of a user interface (UI) to be displayed;
identifying, based on the TID information, whether the first thread belongs to a process of an application associated with a top window among at least one window displayed on a screen; and
including in a thread list the first thread and a second thread that belongs to a same process as the first thread and that is configured to process a task related to the UI based on the first thread being identified as belonging to the process of the application associated with the top window, the thread list being associated with a UI operation of the application,
wherein threads included in the thread list including the first thread and the second thread that are associated with the UI operation are configured such that a scheduling setting different from at least one thread that belongs to the process and is not included in the thread list associated with the UI operation is enabled to be applied.

12. The method of claim 11, wherein the obtaining of the TID information of the first thread comprises:
receiving, from the application, the TID information of the first thread for which the rendering for displaying the UI is requested,
wherein the application requests the rendering for displaying the UI based on a user input that selects or executes the application.

13. The method of claim 11, wherein the method comprises:
receiving, from a window manager, based on identifying that a change of the top window occurs, process information about the process of the application associated with the top window,
wherein the process information includes PID information indicating a process ID (PID) of the process.

14. The method of claim 13, wherein the identifying of whether the first thread belongs to the process of the application associated with the top window comprises:
identifying whether the first thread belongs to the process of the application associated with the top window by comparing TIDs of threads belonging to the process identified by the PID information with the TID of the first thread identified by the TID information.

15. The method of claim 13, wherein the method comprises:
identifying, among threads included in the process, a thread having a TID identical to the PID of the process as the second thread.
